(19) United States
(12) Patent Application Publication
(10) Pub. No.: US 2012/0249992 A1
(43) Pub. Date: Oct. 4, 2012

(54) SUBSTRATE TRANSFER APPARATUS AND SUBSTRATE TRANSFER METHOD

(75) Inventors: Hiroyuki MATSUURA, Oshu-shi (JP); Hiroshi Kikuchi, Oshu-Shi (JP)

(73) Assignee: Tokyo Electron Limited, Tokyo (JP)

(21) Appl. No.: 13/433,769

(22) Filed: Mar. 29, 2012

(30) Foreign Application Priority Data
Mar. 31, 2011 (JP) 2011-077033

(51) Int. Cl. G03B 27/58

(52) U.S. Cl. 355/72

(57) ABSTRACT

A substrate transfer apparatus includes: a transfer base; a plate-like holding member which is configured to hold a substrate and which is horizontally movable back and forth with respect to the transfer base; a piezoelectric body mounted to the holding member and which, when a voltage is applied thereto, contracts or elongates to apply a bending stress to the holding member; and a power supply configured to apply a voltage to the piezoelectric body so as to apply a bending stress, which counteracts deflection that has occurred in the holding member, is applied to the holding member.

### CROSS-REFERENCE TO RELATED APPLICATION

This application is based on and claims the benefit of priorities from Japanese Patent Application No. 2011-077033 filed on Mar. 31, 2011, the entire contents of which are incorporated herein by reference.

### TECHNICAL FIELD

The present disclosure relates to a technique for reducing deflection of a plate-like holding member when it holds a substrate in a substrate transfer apparatus for transferring a substrate between the holding member, which is provided on a transfer base movably back and forth, and a substrate support.

### BACKGROUND ART

In a process for the production of a semiconductor device or an LCD substrate, it is conventional practice to take a substrate out of a substrate container called FOUP, in which a large number of substrates are housed in multiple stages, and transfer the substrate to a module for the next process step by using a substrate transfer apparatus. As shown in FIGS. 27 and 28, the substrate transfer apparatus includes a transfer base 12 which is configured to be rotatable on a vertical axis and vertically movable, and a fork 11 as a holding member, which is movable back and forth with respect to the transfer base 12, for holding the back surface of a semiconductor wafer W (hereinafter referred to simply as “wafer W”) as a substrate. In FIGS. 27 and 28, reference numerals 14 and 15 denote guide members for a wafer W. In a support structure which supports a large number of wafers W in multiple stages, such as a FOUP or a wafer boat for use in a vertical heat treatment apparatus, for the purpose of downsizing of the structure, a vertical transfer margin (herein refers to a clearance provided to prevent collision of the fork 11 and a wafer W with the support structure during transfer of the wafer W) needs to be made small. Therefore, the thickness of the fork 11 is set e.g. at about 3 mm.

In these days, wafers are becoming larger and wafers having a diameter of 450 mm are being studied. An increase in the diameter of a wafer involves an increase in the weight of the wafer. Further, the use of a wafer having a larger size requires elongation of the fork 11 accordingly. In this case, for the reason described above, it is not desirable to increase the thickness of the fork 11 in order to enhance the rigidity. However, when an elongated fork 11 having the same thickness as the conventional one is used, it is possible that due to the weight of a wafer, the distal end of the fork 11 can deflect or bend downward to a non-negligible extent as shown in FIG. 29.

As shown in FIG. 29, the occurrence of such deflection in the fork 11 virtually means an increase in the vertical size (L1) of the fork 11, which necessitates a larger transfer margin upon transfer of a wafer W. In a FOUP or a wafer boat, therefore, the pitch of the arrangement of wafers should necessarily be increased. Thus, the size of a FOUP or a wafer boat must be increased in order to load it with the same number of wafers W as the conventional one. On the other hand, in order to maintain the same size of a FOUP or a wafer boat as the conventional one, the number of wafers W to be loaded must be decreased, which may cause a problem of decreased throughput. A demand therefor exits to prevent the fork 11 from deflecting such that its distal end bends downward when the fork 11 holds a wafer W.

JP3802119B2 (FIGS. 2 and 4) describes a technique of adjusting the tilt of a fork by designing the fork to be rotatable in a direction θ with respect to a support tool and, in addition, designing the support tool to be rotatable in a direction a with respect to an arm. The direction θ refers to the direction of rotation about a horizontal axis extending in the length direction of the fork, while the direction a refers to the direction of rotation about a horizontal axis extending in the width direction of the fork. The document also describes that the support tool or the fork is rotated by means of a piezoelectric device. JP 2007-61920A (FIG. 3, paragraph 0017) describes a technique for correcting a downward deflection of the distal end of a fork in a construction in which the proximal end side of the fork is mounted to a hand by bolts. The technique involves pressing on the fork upward by means of an eccentric piece provided in the hand.

The methods disclosed in the two prior art documents are both to correct the posture of a fork by tilting the fork on its proximal end side, and are not to eliminate deflection of the fork.

### DISCLOSURE SUMMARY

The present disclosure provides a technique for reducing deflection of a holding member holding a substrate.

In one embodiment, there is provided a substrate transfer apparatus which includes: a transfer base; a plate-like holding member for holding a substrate and which is horizontally movable back and forth with respect to the transfer base; a piezoelectric body mounted to the holding member and which, when a voltage is applied thereto, contracts or elongates and applies a bending stress to the holding member; and a power supply for applying a voltage to the piezoelectric body so that such a bending stress as to counteract deflection that has occurred in the holding member is applied to the holding member.

In another embodiment, there is provided a substrate transport method which includes: moving a plate-like holding member, mounted to a transfer base, forward to a position below a substrate held on a support; raising the holding member relative to the support and allowing the holding member to receive the substrate from the support; and applying a voltage to a piezoelectric body, mounted to the holding member, so that the piezoelectric body applies to the holding member such a bending stress as to counteract deflection of the holding member which would be produced when the holding member holds the wafer.

According to the foregoing embodiments, a voltage is applied to the piezoelectric body when the holding member deflects, so that such a bending stress as to warp the holding member upward is applied to the holding member. This can reduce the deflection of the holding member.

### BRIEF DESCRIPTION OF DRAWINGS

FIG. 1 is a schematic side view showing a substrate transfer apparatus in one embodiment, a FOUP and a wafer boat;

FIG. 2 is a plan view of the substrate transfer apparatus;

FIG. 3 is a side view of the substrate transfer apparatus;

FIG. 4 is an enlarged side view of a portion of the substrate transfer apparatus;

FIGS. 5(a) through 5(c) are diagrams illustrating the action of a piezoelectric body provided in the substrate transfer apparatus;

FIG. 6 is a diagram showing a controller for controlling the operation of the substrate transfer apparatus;

FIG. 7 is a graphical diagram of a voltage pattern showing the relationship between the voltage applied to the piezoelectric body and the relative height position of a holding member;

FIG. 8 is a side view illustrating the action of the substrate transfer apparatus;

FIG. 9 is a side view illustrating the action of the substrate transfer apparatus;

FIG. 10 is a side view illustrating the action of the substrate transfer apparatus;

FIG. 11 is a side view illustrating the action of the substrate transfer apparatus;

FIG. 12 is a side view illustrating the action of the substrate transfer apparatus;

FIG. 13 is a side view illustrating the action of the substrate transfer apparatus;

FIG. 14 is a side view illustrating the action of the substrate transfer apparatus;

FIG. 15 is a graphical diagram of a voltage pattern showing the relationship between the voltage applied to a piezoelectric body and the relative height position of a holding member;

FIG. 16 is a side view illustrating the action of the substrate transfer apparatus;

FIG. 17 is a plan view of a substrate transfer apparatus in another embodiment;

FIG. 18 is a circuit diagram of a substrate transfer apparatus in yet another embodiment;

FIG. 19 is a perspective view of a substrate transfer apparatus in yet another embodiment;

FIG. 20 is a plan view of the substrate transfer apparatus shown in FIG. 19;

FIG. 21 is a side view of the substrate transfer apparatus shown in FIG. 19;

FIG. 22 is a diagram illustrating a piezoelectric body provided in the substrate transfer apparatus shown in FIG. 19;

FIG. 23 is a plan view of a substrate transfer apparatus in yet another embodiment;

FIG. 24 is an enlarged side view of a portion of a substrate transfer apparatus in yet another embodiment;

FIGS. 25(a) and 25(b) are diagrams illustrating the action of the substrate transfer apparatus shown in FIG. 24;

FIG. 26 is a graphical diagram of a voltage pattern showing the relationship between the voltage applied to a piezoelectric body and the relative height position of a holding member;

FIG. 27 is a plan view of a conventional substrate transfer apparatus;

FIG. 28 is a side view of the conventional substrate transfer apparatus; and

FIG. 29 is a side view of the conventional substrate transfer apparatus.

### DESCRIPTION OF EMBODIMENTS

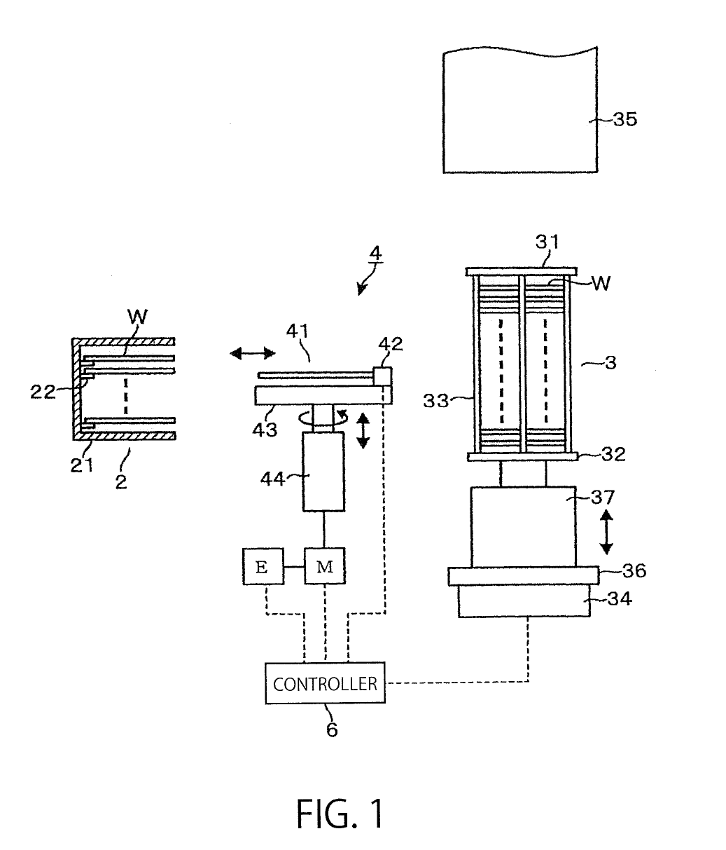

Preferred embodiments will now be described with reference to the drawings. The following description illustrates an exemplary substrate transfer apparatus 4 which, as shown in FIG. 1, transfers a wafer W between a FOUP 2 for housing wafers W and a wafer boat 3 for holding wafers W on shelves. The FOUP 2 is a container for housing a large number of, for example 25, wafers W in multiple stages. A peripheral region of the back surface of each wafer W is placed on a support 22 and the wafers W, arranged at a predetermined pitch in the vertical direction, are housed in a container body 21.

The wafer boat 3 is configured to be capable of holding a large number of, for example 100, wafers W arranged at a predetermined pitch in the vertical direction. For example, the wafer boat 3 has support posts 33 between a top plate 31 and a bottom plate 32, and a peripheral portion of each wafer W is held in a not-shown groove-like support portion formed in each support post 33.

The wafer boat 3 is provided on a vertically-movable boat elevator 34, and is vertically movable between a loading position at which the wafer boat 3 lies in a heat treatment furnace 35 and an unloading position (the position shown in FIG. 1) under the heat treatment furnace 35. A wafer W is transferred by the substrate transfer apparatus 4 between the FOUP 2 and the wafer boat 3 when it lies in the unloading position. In FIG. 1, reference numeral 36 denotes a lid of the heat treatment furnace 35, and 37 denotes a heat-retaining cylinder.

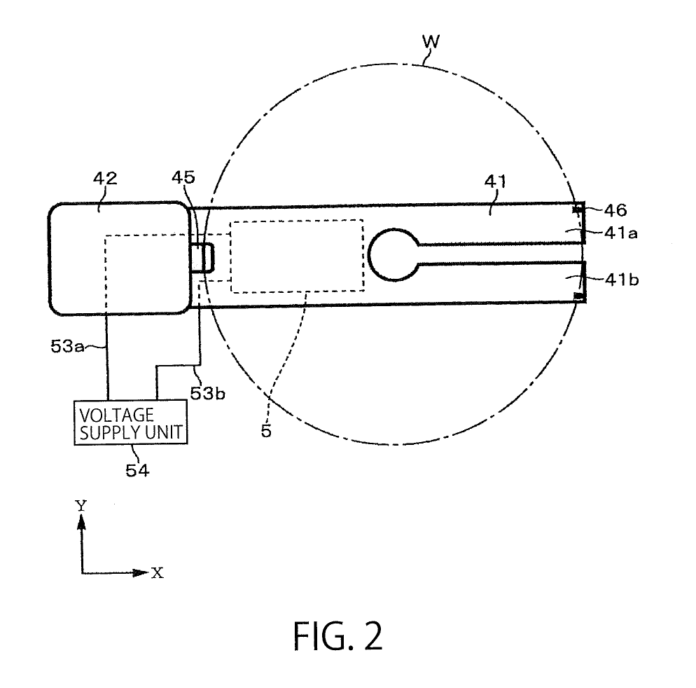

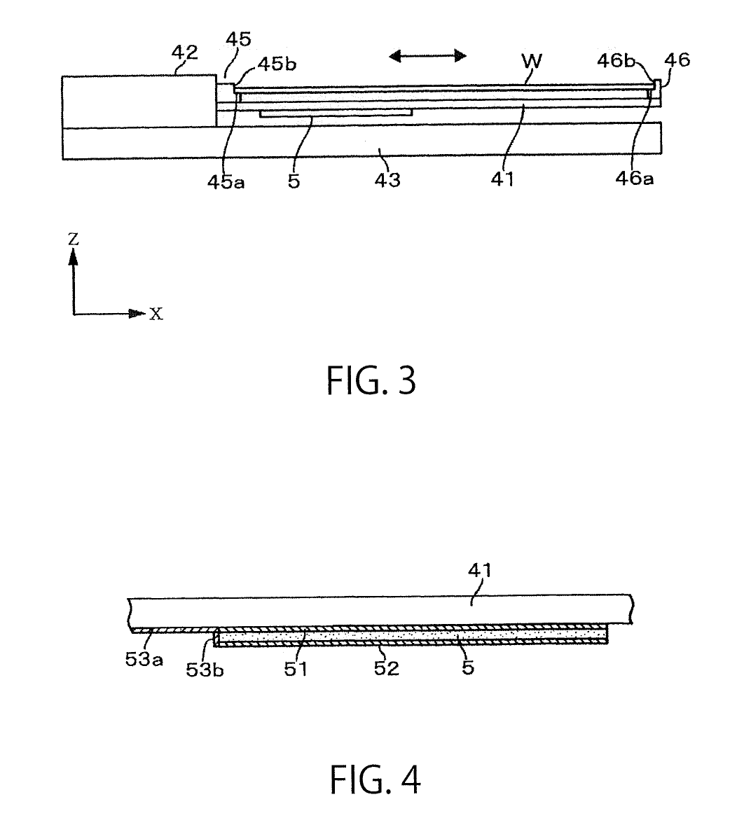

As shown in FIGS. 1 through 3, the substrate transfer apparatus 4 includes a generally-horizontal plate-like holding member 41 for holding the back-surface side of a wafer W. The holding member 41 of this embodiment is composed of e.g. a ceramic material, such as alumina (Al₂O₃). In the illustrated embodiment, the holding member 41 as a whole has a generally-rectangular shape in a planar view; the short sides are each shorter than the diameter of a wafer W, while the long sides are each slightly longer than the diameter of the wafer W. The holding member 41, in its portion ranging from approximately the center to the distal end in the length direction (X direction in FIG. 2), is split into two arm portions 41a, 41b.

The proximal end of the holding member 41 is connected to a back-and-forth movement member 42. The back-and-forth movement member 42 is configured to move back and forth along a transfer base 43 in the length direction (X direction in FIG. 2) of the holding member 41 e.g. by means of a drive mechanism (not shown) using a timing belt, provided in the interior of the transfer base 43. The transfer base 43 is configured to be vertically movable and rotatable on a vertical axis by means of a drive mechanism 44 having a lifting mechanism and a rotating mechanism. The lifting mechanism is, for example, comprised of a lifting motor M which is connected to an encoder E. A pulse value of the encoder E is outputted to the below-described controller 6.

In the illustrated embodiment, guide members 45 and 46 are provided on the upper surface of the holding member 41 at the proximal end and at the distal end, respectively. The guide members 45, 46 have receiving surfaces 45a, 46a for placing a substrate W thereon, and wall portions 45b, 46b rising from the receiving surfaces 45a, 46a and which perform positioning of the wafer W by bringing a portion of the peripheral end surface of the wafer W into contact therewith. A wafer W can be positioned and held by the holding member 41 by placing a peripheral portion of the back surface of the wafer W on the guide members 45, 46.

A piezoelectric body 5 is provided in the proximal end-side non-bifurcated area of the holding member 41. The piezoelectric body 5 is, for example, a film of a piezoelectric ceramic material, such as lead titanate or lead zirconate, having a thickness of about 1 mm, and is bonded to the lower surface of the holding member 41 with a heat-resistant adhesive.

The piezoelectric body 5 has, for example, a rectangular shape and is provide with electrodes 51, 52. As shown in FIG. 4, the electrodes 51, 52 are formed on the upper surface and the lower surface of the piezoelectric body 5, respectively, such that they oppose each other, and are connected via feed lines 53a, 53b, respectively, to a voltage supply unit 54 as an external power supply. In this embodiment the electrodes 51, 52 are provided such that they cover the entire upper surface and the entire lower surface of the piezoelectric body 5, respectively. The electrodes 51, 52 and the feed lines 53a, 53b are each comprised of e.g. a metal layer, and are bonded to the holding member 41 and the piezoelectric body 5 e.g. with a heat-resistant adhesive.

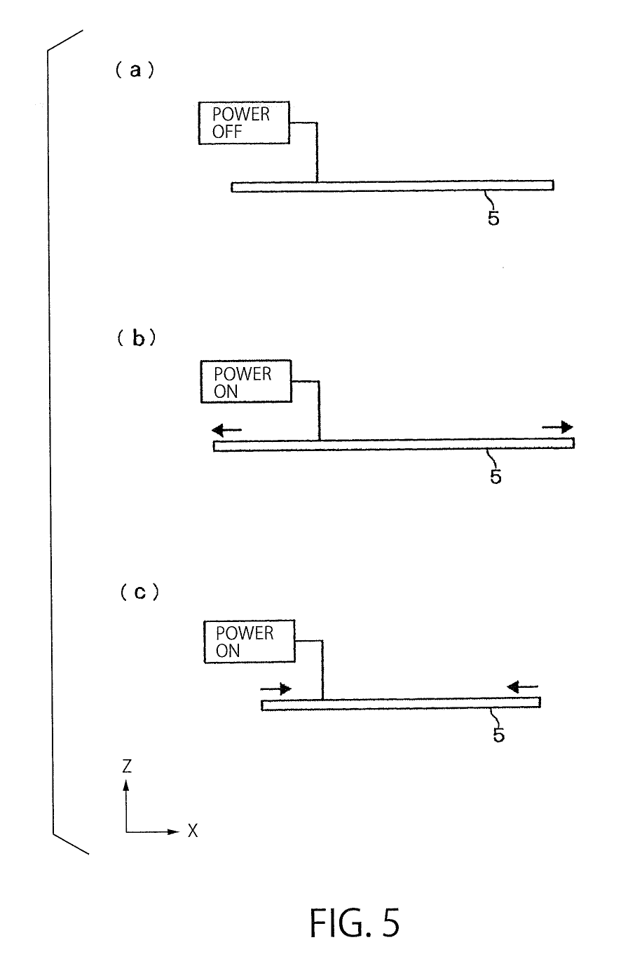

The construction and the location of the piezoelectric body 5 are arbitrary insofar as it does not deform when no voltage is applied thereto as shown in FIG. 5(a), but it deforms and applies a bending stress to the holding member 41 so that the distal end of the holding member 41 warps upward. The piezoelectric body 5, when it is provided on the lower surface of the holding member 41, must be one which elongates in the length direction (X direction in FIG. 2) when a voltage is applied thereto, as shown in FIG. 5(b). Because the lower-surface side of the holding member 41 elongates by the application of a voltage, such a bending stress as to warp the holding member 41 upward is applied to the holding member 41.

It is also possible to provide the piezoelectric body 5 on the upper surface of the holding member 41. In this case, the piezoelectric body 5 must be one which contracts in the length direction (X direction in FIG. 2) when a voltage is applied thereto, as shown in FIG. 5(c). Because the upper-surface side of the holding member 41 contracts by the application of a voltage, such a bending stress as to warp the holding member 41 upward is applied to the holding member 41.

In this embodiment the piezoelectric body 5 is designed to elongate by the inverse piezoelectric effect when applying a voltage to it with the upper surface-side electrode 51 as a positive electrode and the lower surface-side electrode 52 as a negative electrode. The elongation of the piezoelectric body 5 is proportional to the voltage applied.

Thus, when the piezoelectric body 5 is provided on the lower surface of the holding member 41 with the length direction (elongation direction) of the piezoelectric body 5 coinciding with the length direction of the holding member 41, and the electrodes 51, 52 are provided as shown in FIG. 4, the piezoelectric body 5, when a voltage is applied thereto, applies to the holding member 41a bending stress which causes the holding member 41 to warp upward, whereby the holding member 41 deforms such that its distal end side warps upward. The voltage supply unit 54 is configured to apply a voltage to the piezoelectric body 5 based on a control signal from a controller 6.

When the thus-constructed substrate transfer apparatus 4 receives a wafer W from the FOUP 2, the height of the holding member 41 is first adjusted by a vertical movement of the transfer base 43, and then the holding member 41 is moved forward to a position below the wafer W held on a support 22 in the FOUP 2. Next, the holding member 41 is raised to receive the substrate W on it from the support 22. After raising the holding member 41 to a position where the support 22 does not interfere with the wafer W, the holding member 41 holding the wafer W is moved backward from the FOUP 2. In the sequence of operations, the operation of vertically moving the holding member 41 is performed by vertically moving the transfer base 43. The following description illustrates the operation of the holding member 41 when it receives a wafer W from a support 22 of the FOUP 2.

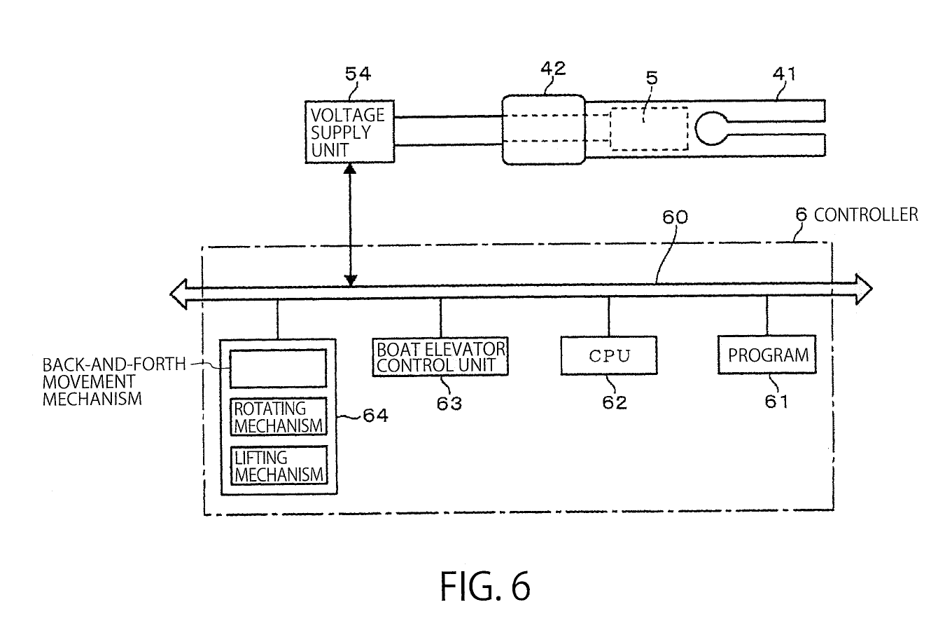

The controller 6 will now be described with reference to FIG. 6. The controller 6 is, for example, comprised of a computer and includes a program 61, a CPU 62, a boat elevator control unit 63 and a transport control unit 64. The boat elevator control unit 63 is to control the vertical movement of the boat elevator 34, and the transport control unit 64 is to control the drive mechanism for the back-and-forth movement member 42 of the substrate transfer apparatus 4, and the drive mechanism 44 having a rotating mechanism and a lifting mechanism. In FIG. 6, reference numeral 60 denotes a bus.

The program 61 contains instructions (steps) for causing the controller 6 to send a control signal to the substrate transfer apparatus 4 via the transport control unit 64, thereby causing the substrate transfer apparatus 4 to perform a predetermined substrate transport operation. The program 61 is stored in a storage unit or medium, such as a flexible disk, a compact disk, a hard disk or an MO (magnetooptical disk) and installed in the controller 6. The program 61 also contains instructions (steps) for causing the controller 6 to output a control command to the voltage supply unit 54 so that it applies a voltage in a predetermined pattern to the piezoelectric body 5 when the holding member 41 holds a wafer W.

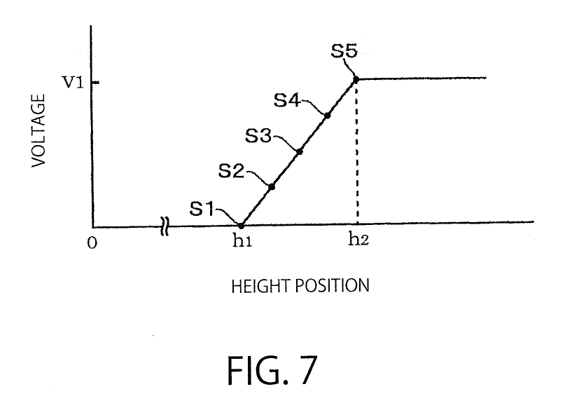

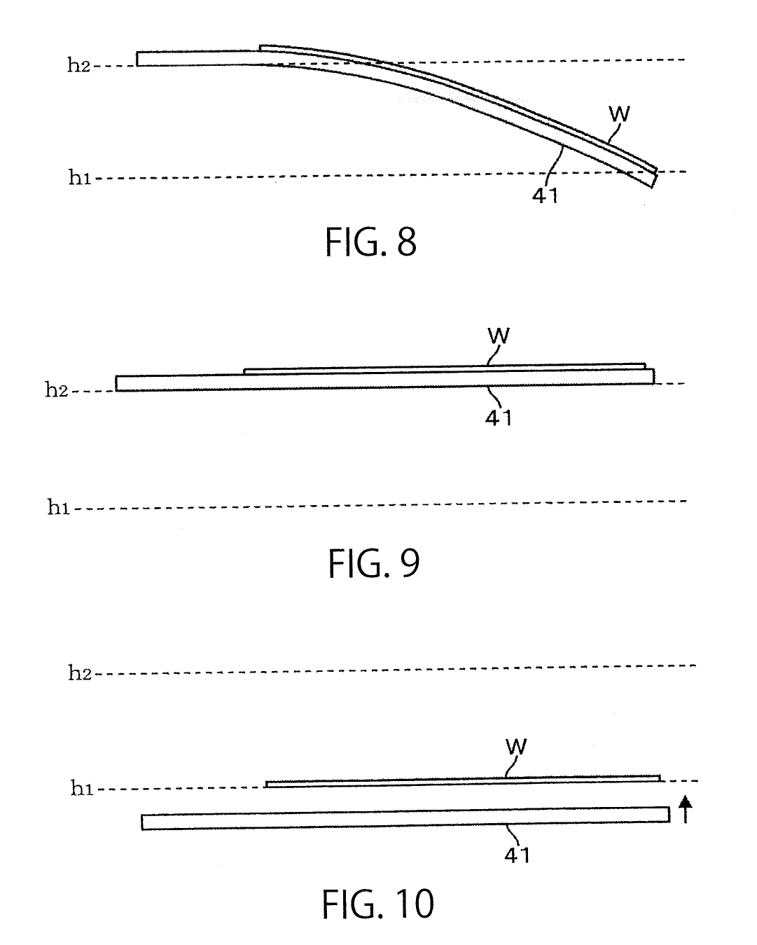

In particular, the voltage supply unit 54 is configured to generate a voltage in the pattern shown in FIG. 7. The voltage pattern shows the relationship between the relative height position of the holding member 41 and the voltage applied to the piezoelectric body 5. In FIG. 7, the abscissa represents the relative height of the holding member 41, and the ordinate represents the voltage applied to the piezoelectric body 5. The height position h1 is the height position of the proximal end of the holding member 41 at the time point when the holding member 41, rising from a position below a wafer W held on a support 22, comes into contact with the wafer W, i.e. when the upper surface of the holding member 41 comes into contact with the lower surface of the wafer W. The height position h2 is the height position of the proximal end of the holding member 41, as shown in FIG. 8, at the time point when the wafer W leaves the support 22 during the course of raising the holding member 41 while a voltage is not applied to the piezoelectric body 5 so that the distal end portion of the holding member 41 bents downward due to the weight of the wafer W (Note that, since the wafer W and the holding member 41 are warped, the part of the wafer W corresponding to the distal end portion of the holding member 41 is in contact with the support 22 immediately before the wafer W leaves the support 22).

The holding member 41 can be mover vertically by moving the transfer base 43 by means of the drive mechanism 44; the relative height positions h1, h2 can be detected by a pulse value of the encoder E of the lifting motor M of the drive mechanism 44. The values of the relative height positions h1, h2 are common to all the supports 22 of the FOUP 2 and all the support portions of the wafer boat 3.

The voltage pattern is set such that a higher voltage is applied to the piezoelectric body 5 when a wafer W is held on the holding member 41 than when the wafer W is not held on the holding member 41 and, in this embodiment, the voltage is set to zero when no wafer is held on the holding member 41. Furthermore, the voltage pattern is set such that the voltage is higher after the wafer W leaves the support 22 by the rise of the holding member 41 than when the holding member 41 lies at the height position h1.

More specifically, as shown in FIG. 7, the voltage is zero until the holding member 41 is raised to the height position h1 after moving the holding member 41 forward to a position below a wafer W to be held on the holding member 41. The application of a voltage is started when the proximal end of the holding member 41 has reached the height position h1. The voltage is increased gradually in proportion to increase in the height of the holding member 41, while a constant voltage V1 is applied after the holding member 41 has reached the height position h2.

When the holding member 41 receives a wafer W from a support 22, the upper surface of the holding member 41 at the height position h1 makes contact with the lower surface of the wafer W. At this time point the wafer W is held on the support 22, and therefore the weight of the wafer W is not applied to the holding member 41. If a high voltage is applied at once when no or little load of the wafer W is applied to the holding member 41, then the distal end of the holding member 41 will warp upward, which can cause displacement of the wafer W on the holding member 41. In the case of applying a high voltage at once when the proximal end of the holding member 41 has reached the height position h2, on the other hand, it becomes impossible to make the pitch of wafers W, arranged e.g. in the FOUP 2 in the vertical direction, smaller than (h2−h1). In this embodiment, therefore, the voltage pattern is set such that the voltage application is started when the proximal end of the holding member 41 has reached the height position h1, and that the voltage increases continuously with the rise of the holding member 41 until it reaches the height position h2. When a voltage is applied to the piezoelectric body 5 in this manner, the posture of the holding member 41 can be corrected such that it takes a generally-horizontal position as shown in FIG. 9 when the proximal end of the holding member 41 comes to the height position h2.

An applied voltage (zero in the embodiment shown in FIG. 7) at the height position h1 and an applied voltage (V1 in the embodiment shown in FIG. 7) at the height position h2 can be determined experimentally in advance. The applied voltage in the height range between the height position h1 and the height position h2 may be changed either in proportion to change in the height or in a stepwise fashion, taking experimentally-determined values. In FIGS. 8 through 14 and FIG. 16, the distance between the height positions h1 and h2, and the degree of deflection of the holding member 41 are exaggerated for easier understanding thereof. In FIG. 12, W(S1) to W(S5) indicate the states of the wafer W in the steps S1 to S5 shown in FIG. 7, respectively.

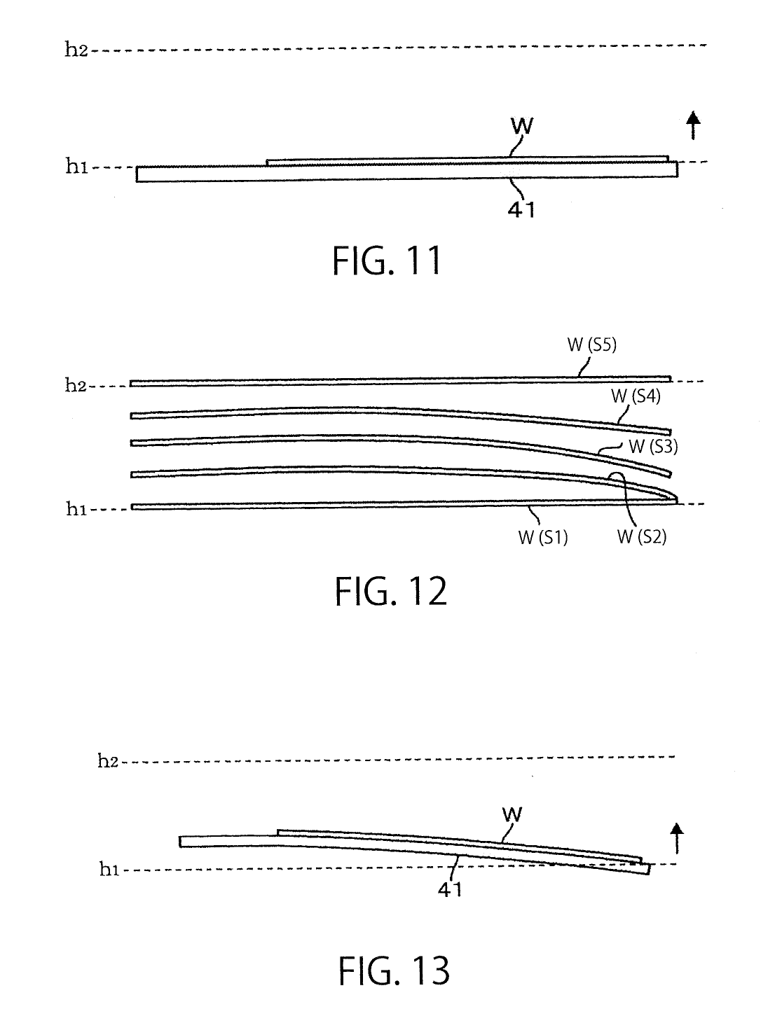

The operation of the substrate transfer apparatus 4 will now be described with reference to FIGS. 10 to 14 in the case where a wafer W in the FOUP 2 is transferred to the wafer boat 3. First, as shown in FIG. 10, the holding member 41 is moved forward to a position below a wafer W to be transferred. The wafer W is supported on a not-shown support 22. Next, as shown in FIG. 11, the holding member 41 is raised, and the proximal end of the holding member 41 reaches the height position h1. At this time point the weight of the wafer W is not applied to the holding member 41, as described previously, and the holding member 41 is in a horizontal position as shown by the wafer W(S1) in FIG. 12.

The application of a voltage to the piezoelectric body 5 is started, and the holding member 41 is raised while gradually increasing the voltage applied to the piezoelectric body 5. By the application of a voltage, the holding member 41 deforms such that its distal end warps upward. Because the applied voltage is increased as the load applied from the wafer W to the holding member 41 increases with the rise of the holding member 41, the wafer W is unlikely to bounce up. Further, because the holding member 41 itself is rising, the movement of the holding member 41 reduces the influence of deformation of the holding member 41 on the wafer W, and displacement of the wafer W can be prevented by the guide members 45, 46.

With reference to the wafer W(S2) of FIG. 12, corresponding to the step S2 of FIG. 7, while the proximal end of the holding member 41 has been raised to a position higher than the height position h1, the distal end of the wafer W is still placed on the support 22 as shown in FIG. 13. Accordingly, a certain proportion of the own weight of the wafer W is applied to the holding member 41. At this stage, deflection of the holding member 41 is small and the applied voltage is low. With reference to the wafer W(S3) corresponding to the step S3, the distal end of the wafer W has left the support 22 due to the further rise of the holding member 41. At this stage, in view of increased load applied to the holding member 41, a higher voltage than that of the step S2 is applied to the piezoelectric body 5. In the step S4, a higher voltage than that of the step S3 is applied to the piezoelectric body 5. Therefore, the bending stress, which is produced by the piezoelectric body 5 and which causes the holding member 41 to warp upward, is larger, whereby the holding member 41 takes a more horizontal position.

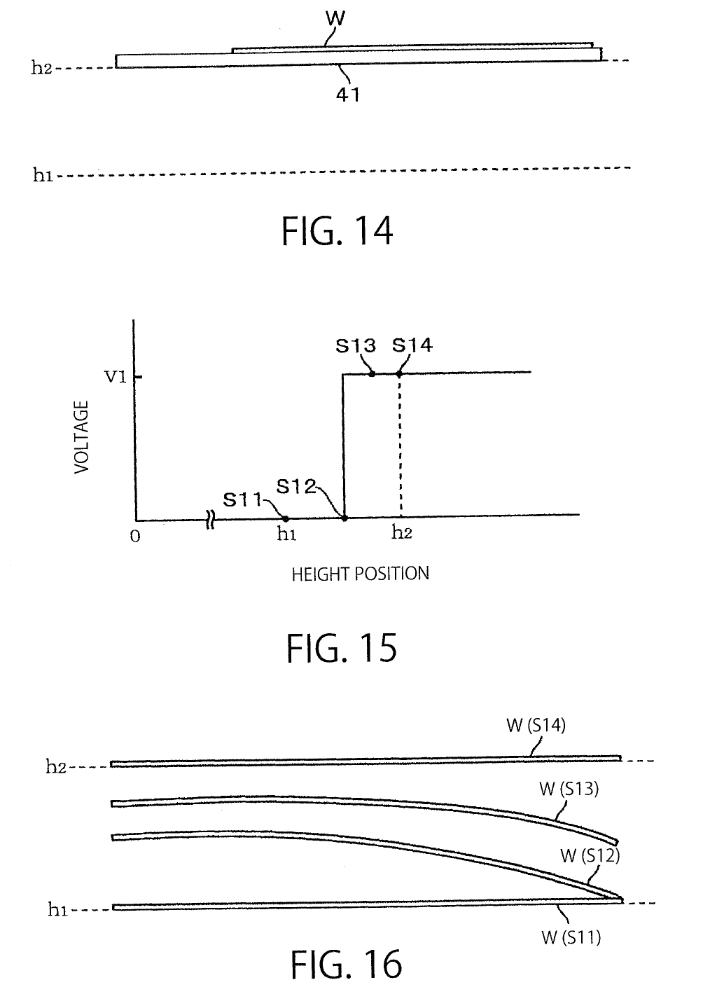

FIG. 14 shows the wafer W(S5) in the step S5 of FIG. 7 when the proximal end of the holding member 41 has reached the height position h2. In the step S5, a voltage V1, which is higher than that of the step S4, is applied to the piezoelectric body 5. Therefore, the bending stress, applied from the piezoelectric body 5 to the holding member 41, becomes larger whereby the holding member 41 takes a substantially horizontal position. By thus continuously increasing the voltage applied to the piezoelectric body 5 according to the rise in the height position of the holding member 41, deflection of the holding member 41 due to the weight of the wafer W is compensated for (counteracted) by deformation of the holding member 41 caused by the piezoelectric body 5. This makes it possible to raise the holding member 41 in a nearly horizontal position while preventing displacement of a wafer W, and to keep the holding member 41 in a substantially horizontal position at the height position h2.

When transferring the wafer W held on the holding member 41 to e.g. a support portion of the wafer boat 3, the holding member 41 is moved forward to a position above the support portion of the wafer boat 3 while continuing to apply the voltage V1 to the holding member 41. Next, the holding member 41 is lowered from the position to transfer the wafer W to the support portion. During the period when the holding member 41 is lowered from the height position h2 to the height position h1 with respect to the support portion of the wafer boat 3, the voltage applied to the piezoelectric body 5 is controlled so that it continuously decreases in the pattern shown in FIG. 7; the voltage is made zero when the holding member 41 has reached the height position h1. The holding member 41 is moved backward after lowering it to a position below the height position h1.

The sequence of the above-described operations is repeated to transfer wafers W in the FOUP(s) 2 to the wafer boat 3. Thereafter, the boat elevator 34 is raised to carry the wafer boat 3 to the loading position in the vertical heat treatment furnace 35, where a predetermined heat treatment of a large number of wafers W is performed at a time. After the heat treatment, the wafer boat 3 is lowered to the unloading position, and the wafers W on the support portions of the wafer boat 3 are transferred one by one to the supports 22 of a FOUP(s) 2 in the above-described manner.

According to the above-described embodiment, the holding member 41 is provided, on the lower surface, with the piezoelectric body 5 whose upper-surface side elongates when a voltage is applied. Therefore, such a bending stress as to warp the distal end of the holding member 41 upward can be applied to the holding member 41 which deflects or bends when it holds a wafer W. Thus, deflection of the holding member 41 due to the weight of the wafer W can be compensated for by the elongation deformation of the piezoelectric body 5. This makes it possible to reduce deflection of the holding member 41 and keep the holding member 41, holding a wafer W, in a substantially horizontal position.

The voltage applied to the piezoelectric body 5 is increased gradually according to the height position of the proximal end of the holding member 41. Therefore, even though the holding member 41 is deformed by the piezoelectric body 5 such that the holding member 41 warps upward, the holding member 41 can be deformed according to the degree of deflection of the holding member 41 due to the load of a wafer W. It therefore becomes possible to raise the holding member 41 while preventing displacement of a wafer W on the holding member 41 and keeping the holding member in a horizontal or nearly horizontal position.

Consequently, even when holding a wafer W having a large size, e.g. 450 mm, an increase in the vertical size of the holding member 41 in the entire area from the proximal end to the distal end (i.e. the distance between the highest height position and the lowest height position of the holding member) can be reduced. This can reduce an increase in the vertical transfer margin for transfer of a wafer W. Therefore, the arrangement pitch of wafers W can be made small in a structure, such as the FOUP 2 or the wafer boat 3, which houses a large number of wafers in multiple stages. It thus becomes possible to prevent an increase in the size of an apparatus including such a structure for housing a large number of wafers in multiple stages. Furthermore, a larger number of wafers W can be housed in a region, having a certain volume, of an apparatus, leading to an increased productivity.

In addition, the piezoelectric body 5 is provided on the lower surface of the holding member 41. There is, therefore, little fear of contact between the piezoelectric body 5 and a wafer W, and contamination of the wafer W can be prevented.

Another exemplary voltage pattern, to be applied to the piezoelectric body 5, will now be described with reference to FIGS. 15 and 16. In the voltage pattern, the voltage is increased at once (discontinuously) according to the rise of the holding member 41. In particular, a certain voltage is applied to the piezoelectric body 5 instantaneously when the proximal end of the holding member 41 has reached a particular height position between the height position h1 and the height position h2. The step S11 of FIG. 15 corresponds to the time point when the proximal end of the holding member 41 has reached the height position h1. As described previously, at this time point a wafer W is held on a support 22, and therefore the wafer W is in a horizontal position as will be appreciated also from the wafer W(S11) shown in FIG. 16.

The holding member 41 is continued to be raised. The step S12 of FIG. 15 corresponds to the time point when the proximal end of the holding member 41 lies at an intermediate height position between the height position h1 and the height position h2. At this time point, as will be appreciated from the wafer W(S12) of FIG. 16, the distal end (supported on the distal end of the holding member 41) of the wafer W is still on the support 22, and the distal end of the holding member 41 is bent or deflected downward. The application of a voltage V1 to the piezoelectric body 5 is started at this time point. Because a certain proportion of the weight of the wafer W is applied to the holding member 41 at this time point, the wafer W is unlikely to bounce up even when the holding member 41 is contracted by the application of the voltage V1 to the piezoelectric body 5. Also because the holding member 41 itself is rising, displacement of the wafer W can be prevented.

After the step S12, the application of the voltage to the piezoelectric body 5 produces such a bending stress as to warp the distal end of the holding member 41 upward, whereby the degree of downward deflection of the distal end of the holding member 41 gradually decreases, i.e. the distal end of the holding member 41 gradually rises. FIG. 16 shows the wafer W(S13) on the holding member 41 whose distal end is rising, and the wafer W(S14) on the holding member 41 whose distal end has stopped rising. Also by thus starting the full application of the constant voltage V1 when the proximal end of the holding member 41 lies at an intermediate height position between the height position h1 and the height position h2, deflection of the holding member 41 due to the weight of a wafer W can be compensated for while preventing displacement of the wafer W and, in addition, the wafer W can be held in a substantially horizontal position at the height position h2.

Also in the voltage pattern shown in FIG. 15, a larger voltage is applied to the piezoelectric body 5 when a wafer W is held on the holding member 41 in the step 12 than when the wafer W is not held on the holding member 41, and the voltage is set to zero when no wafer is held on the holding member 41. Furthermore, the voltage is set to be higher after the wafer W leaves the support 22 by the rise of the holding member 41 than when the holding member 41 lies at the height position h1.

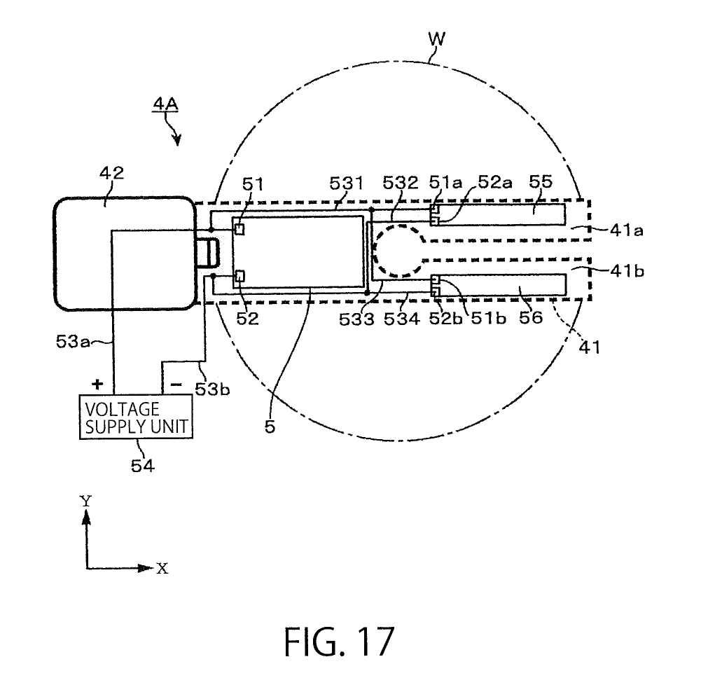

A substrate transfer apparatus in another embodiment will now be described with reference to FIG. 17. The substrate transfer apparatus 4A of this embodiment additionally has piezoelectric bodies 55, 56 also in the distal end-side arm portions 41a, 41b of the holding member 41. The piezoelectric bodies 55, 56 each have a long rectangular shape in conformity with the shape of each of the arm portions 41a, 41b and, as with the piezoelectric body 5, are bonded to the lower surfaces of the arm portions 41a, 41b with a heat-resistant adhesive.

As with the piezoelectric body 5, the piezoelectric body 55 is provided, on its upper surface, with an electrode 51a and provided, on its lower surface, with an electrode 52a. The electrode 51a is connected to the voltage supply unit 54 via a feed line 531 and the feed line 53a, while the electrode 52a is connected to the voltage supply unit 54 via a feed line 532 and the feed line 53b. As with the piezoelectric body 5, the piezoelectric body 56 is provided, on its upper surface, with an electrode 51b and provided, on its lower surface, with an electrode 52b. The electrode 51b is connected to the voltage supply unit 54 via a feed line 533, the feed line 531 and the feed line 53a, while the electrode 52b is connected to the voltage supply unit 54 via a feed line 534, the feed line 532 and the feed line 53b. Though in FIG. 17 the electrodes 51, 51a, 51b and the electrodes 52, 52a, 52b are, for convenience of depiction, depicted as if they are disposed on the upper surface of the holding member 41, their actual vertical positions are as described above.

The piezoelectric bodies 55, 56 are constructed such that they do not deform when no voltage is applied thereto, whereas they elongate in the length direction (X direction in FIG. 17) when a voltage is applied thereto. In this embodiment a voltage is applied from the voltage supply unit 54 such that the electrodes 51, 51a, 51b become positive electrodes, while the electrodes 52, 52a, 52b become negative electrodes. Further, also to the piezoelectric bodies 55, 56, the voltage supply unit 54 applies a voltage according to the height position of the holding member 41, e.g. in the voltage pattern shown in FIG. 7 or 15. The other construction of the substrate transfer apparatus 4A is the same as the above-described substrate transfer apparatus 4 shown in FIG. 2.

In this embodiment the piezoelectric bodies 5, 55, 56 are provided on the lower surface of the holding member 41 over the entire length of the holding member 41. Accordingly, when a voltage is applied to the piezoelectric bodies 5, 55, 56, such a bending stress as to warp the distal end of the holding member 41 upward is produced over the entire length of the holding member 41 by the elongation of the piezoelectric bodies 5, 55, 56. This can increase the degree of the upward deformation of the holding member 41, making it possible to keep the holding member 41 in a more horizontal position even in the case where the degree of deflection of the holding member 41, when it holds a wafer W, is large.

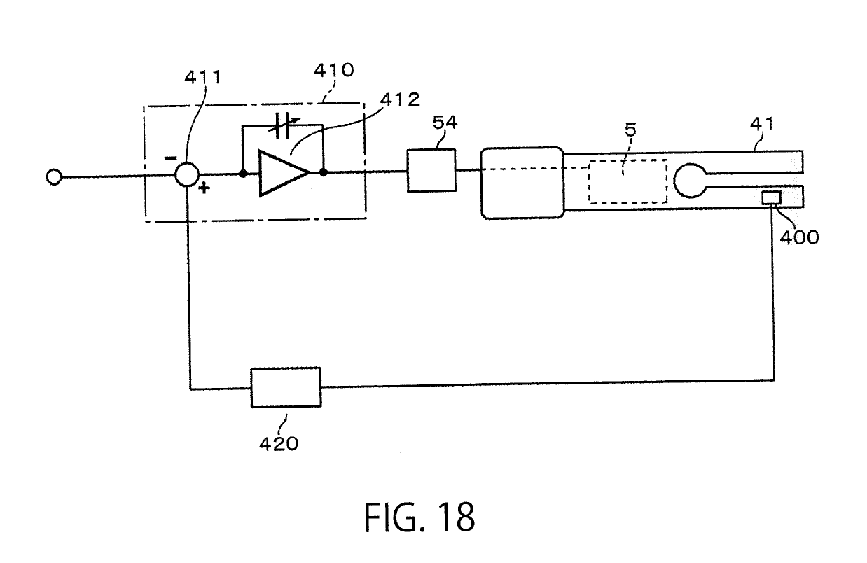

A substrate transfer apparatus in yet another embodiment will now be described with reference to FIG. 18. The substrate transfer apparatus of this embodiment is provided with a deflection detector for detecting the degree of deflection of the holding member 41, and is designed to correct or reduce the degree of deflection of the holding member 41 by controlling, based on a detection value of the deflection detector, the voltage applied from the voltage supply unit 54 to the piezoelectric body 5. A strain sensor 400 such as a strain gauge, for example, can be used as the defection detector. The strain sensor 400 is provided e.g. on the supper surface of the distal end of the holding member 41 as shown in FIG. 18. The strain sensor 400 may be provided on the lower surface of the holding member 41 or in the interior of the holding member 41.

In this embodiment, the target strain of the holding member 41 (i.e., set variable) is input to a voltage controller 410; and a detection signal of the strain sensor 400, which is the actual strain of the holding member 41 as a feedback signal or a process variable, is input to the voltage controller 410 through a signal convertor 420 having a function of a strain amplifier. The target strain is typically “±0”, that is, the goal is to achieve horizontal posture (not warped) of the holding member 41.

The voltage controller 410 calculates, based on the difference between the target strain and the actual strain detected by strain sensor 400, a voltage to be applied to the piezoelectric body 5 that is necessary to render the difference zero. The voltage controller 410 output a control signal to the voltage supply unit 54 so that the voltage supply unit 54 output the thus calculated voltage to the piezoelectric body 5. The piezoelectric body 5 thus elongates so that horizontal position of the holding member 41 is achieved. In the illustrated embodiment, voltage controller 410 is composed of an adder 411 for calculating the difference between the target strain and the actual strain, and an amplifier 412 having an integration function. Any type of feedback control (for example PID control) may be employed.

The target strain must be set to “±0” as mentioned above, if it is necessary to eliminate deflection of the holding member 41 produced by its own weight when no wafer is held on the holding member 41, and to thereby keep the holding member 41 in a horizontal position. In this case, even when no wafer is held on the holding member 41, a fixed voltage Eo or a bias voltage Eo is always applied to the piezoelectric body 5. When a wafer W is held on the holding member 41 the sum of a voltage E corresponding to a load applied to the holding member 41 by the wafer W and the bias voltage Eo is applied to the piezoelectric body 5.

If deflection of the holding member 41 produced by its own weight is acceptable, target strain may be set to “ε”, where “ε” is a constant and is equivalent to a strain measured by the strain sensor 400 when no wafer is held on the holding member 41. Alternatively, target strain may be set to “±0”, while the initializing (zero point adjustment) of the strain amplifier (signal convertor 420) is performed when no wafer is held on the holding member 41.

By thus detecting the degree of deflection of the holding member 41 with the strain sensor 400, and controlling the voltage, applied to the piezoelectric body 5, based on the detection value, it becomes possible to cause the piezoelectric body 5 to elongate, following the occurrence of deflection of the holding member 41. This makes it easier to keep the holding member 41 in a nearly horizontal position and can quickly stabilize the holding member 41, holding a wafer W, in a substantially horizontal position.

Instead of a strain sensor, it is possible to use an optical sensor as a deflection detector. The optical sensor is, for example, a line sensor having a plurality of optical axes arranged in the vertical direction. The optical axes are arranged in such a manner that they are partly blocked when the holding member 41 holds a wafer W. The degree of deflection of the holding member 41 is detected by the positions of the optical axes blocked by the holding member 41. As with the embodiment shown in FIG. 18, the voltage supply unit 54 is configured to output a voltage according to the difference between a detection value as a feedback signal from the optical sensor and a set value of the voltage applied to the piezoelectric body 5.

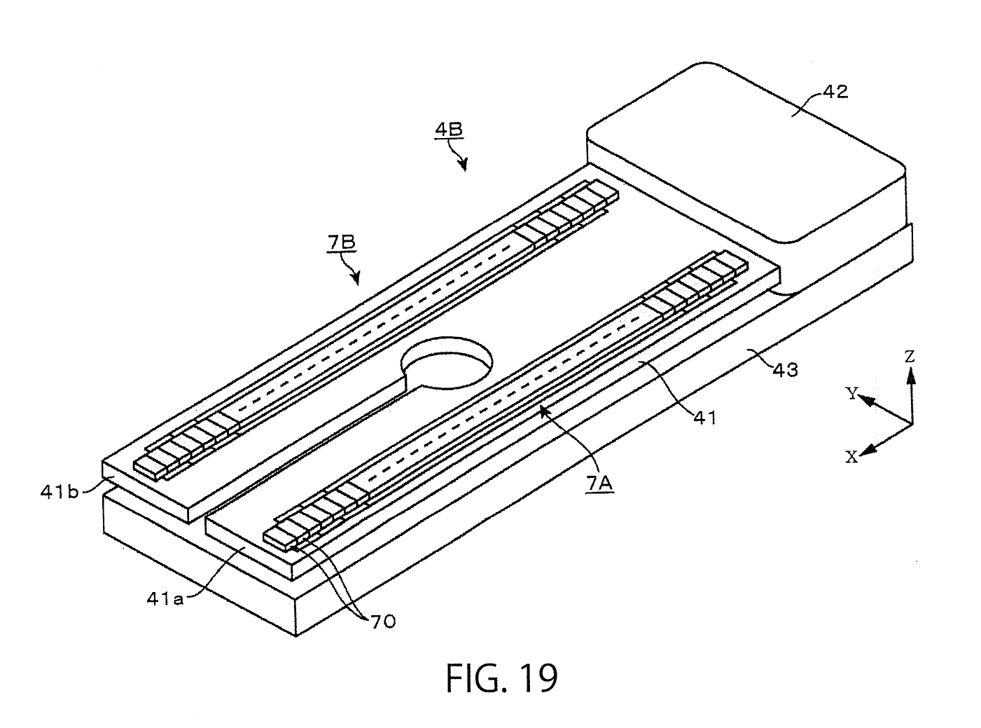

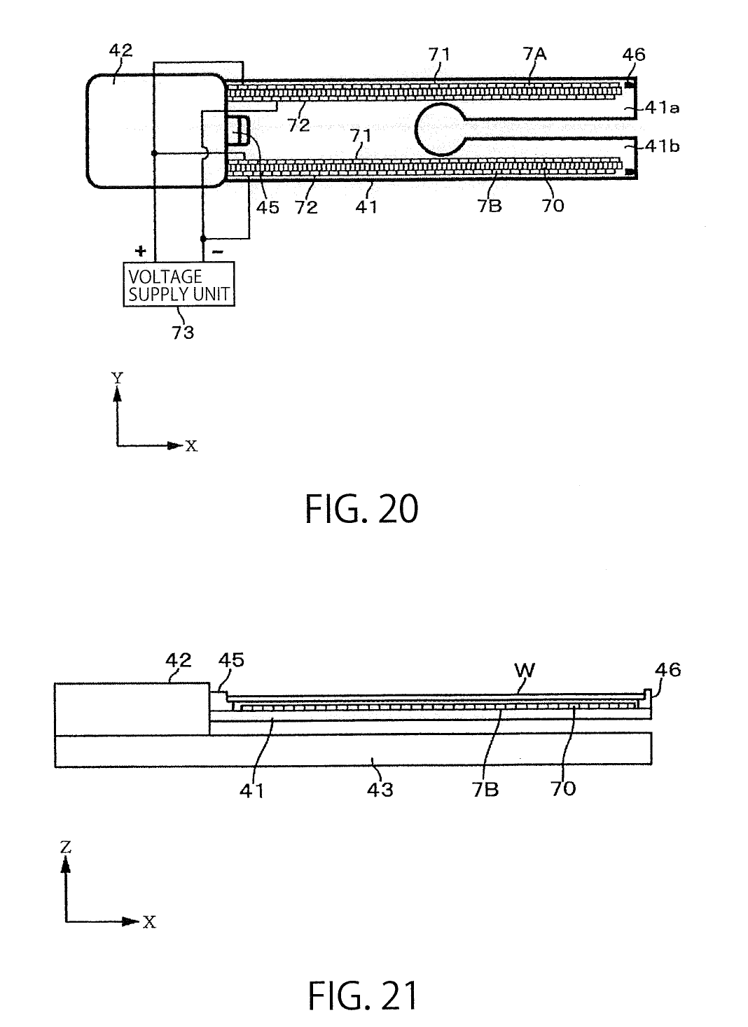

A substrate transfer apparatus in yet another embodiment will now be described with reference to FIGS. 19 through 23. The substrate transfer apparatus 4B of this embodiment differs from the substrate transfer apparatus 4 of the above-described embodiment in that instead of the film-like piezoelectric body 5, piezoelectric devices 7 (7A, 7B), each constructed as a so-called “piezoelectric body stack” consisting a large number of piezoelectric bodies 70 arranged in a line. In this embodiment the piezoelectric devices 7 are provided on the upper surface of the holding member 41.

As shown in FIG. 19, the piezoelectric bodies 70 each have a thin plate-like shape, and are arranged over the entire length of the holding member 41 (X direction in FIG. 19) on both sides of the holding member 41 in the width direction (Y direction in FIG. 19). The piezoelectric bodies 70 are composed of e.g. lead titanate.

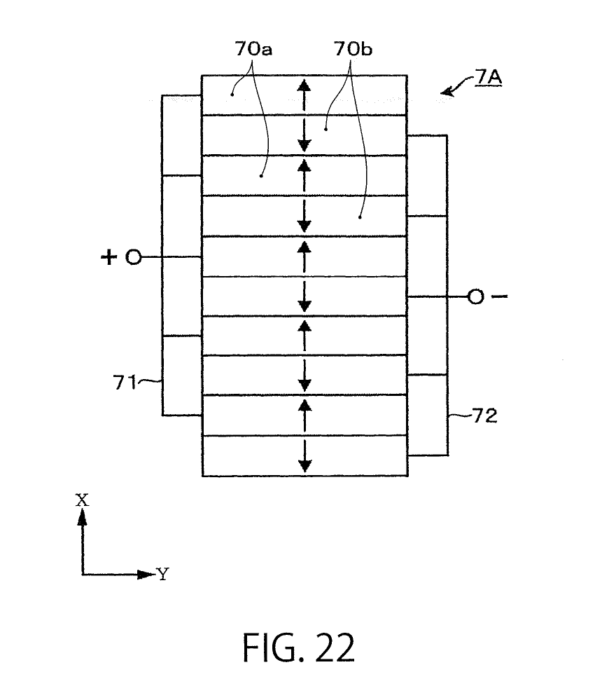

The piezoelectric bodies 70 are connected such that an input voltage is applied in parallel to them. In particular, as shown in FIGS. 19 and 22, alternate piezoelectric bodies 70a and 70b are respectively connected via feed lines 71 and 72 to the positive pole and the negative pole of a voltage supply unit 73. The arrows in FIG. 22 each indicate the direction of polarization. The feed lines 71, 72 are each comprised of e.g. a metal layer. The feed lines 71, 72 can be formed by forming the metal layer on the surface of the holding member 41, printing a circuit pattern on the metal layer, and removing the unnecessary portion of the metal layer.

The piezoelectric bodies 70a and 70b are arranged such that their polarization directions align in the length direction of the holding member 41 and that the polarization directions of the piezoelectric bodies 70a are from the proximal end toward the distal end of the holding member 41 (the piezoelectric bodies 70b have the opposite polarization direction), so that the piezoelectric bodies 70a and 70b, when a voltage is applied thereto, contract in the length direction of the holding member 41.

Also in this embodiment, a voltage is applied to the piezoelectric bodies 70a and 70b in the pattern shown in FIG. 7 or 15, and a wafer W is transferred between the FOUP 2 and the wafer boat 3 by means of the substrate transfer apparatus 4B in the same manner as in the preceding embodiments.

According to this embodiment, the piezoelectric devices 7, each comprising a stack of the large number of piezoelectric bodies 70 and provided on the upper surface of the holding member 41, deform (contract) greatly as a whole when a voltage is applied thereto. Therefore, even when the holding member 41 deflects greatly due to the weight of a wafer W, e.g. in the case of a large-sized wafer, the deflection can be compensated for and the holding member 41 can take a horizontal or nearly horizontal position.

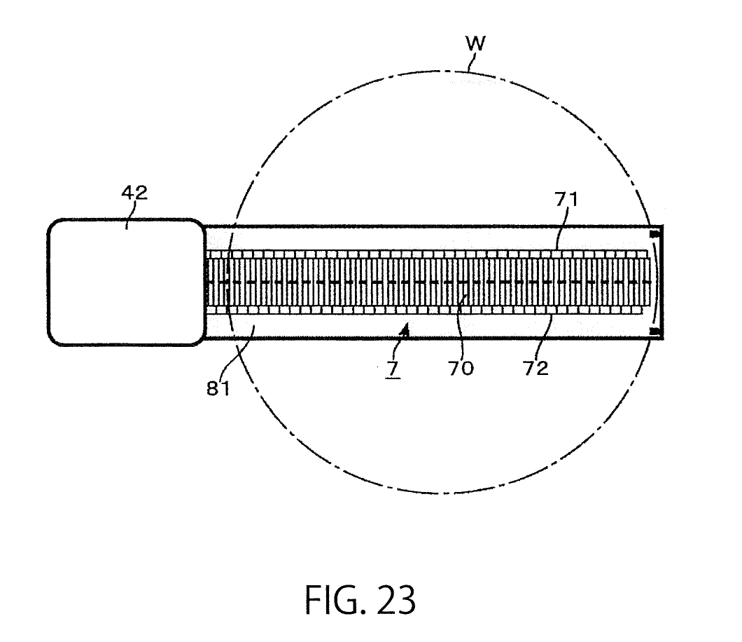

As a holding member for a substrate transfer apparatus, it is possible to use a holding member 81 as shown in FIG. 23 which, unlike the above-described holding member 41 having the two split front-side arm portions, has a non-bifurcated shape. In particular, the holding member 81 has a rectangular shape which, when a wafer W is placed on it, extends centrally and diametrically along the back surface of the wafer W. In the case where the piezoelectric device 7, consisting of a large number of piezoelectric bodies 70, is provided in the holding member 81, the piezoelectric bodies 70 may be arranged on the upper surface of the holding member 81 along the length direction of the holding member 81. It is also possible to provide the piezoelectric body 5, shown in FIG. 2 or 17, in the holding member 81 of this shape.

In the embodiments shown in FIGS. 19 and 23, the piezoelectric bodies 70 are arranged over the entire length of the holding member 41 or 81. The number of the piezoelectric bodies 70 and the area of the holding member 41 or 81 for installation of the piezoelectric bodies 70 may be appropriately selected depending on the degree of deflection of the holding member 41 or 81. The installation area and the size of the piezoelectric body 5, and the number of piezoelectric bodies 5 may also be appropriately selected depending on the degree of deflection of the holding member 41 or 81. It is also possible to use a vertical stack of piezoelectric bodies 5.

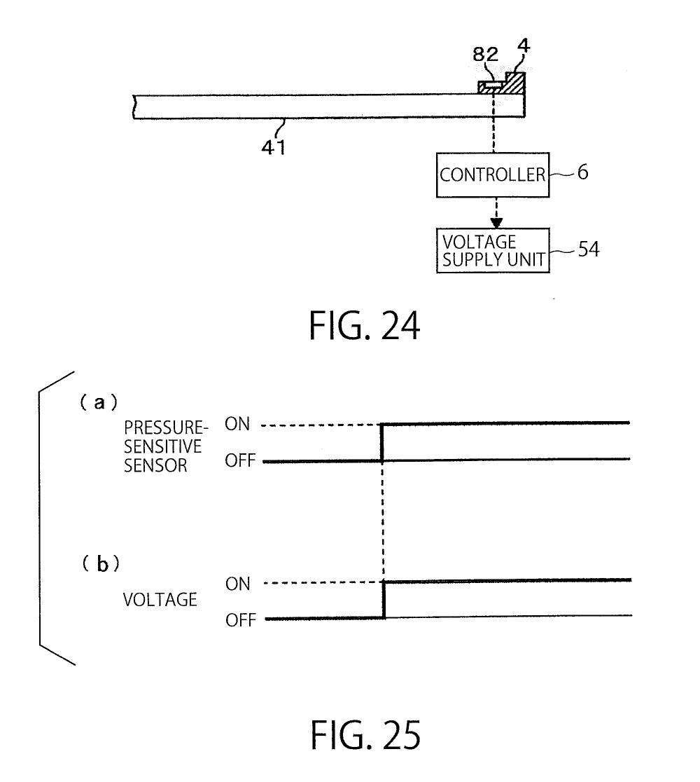

In the above-described embodiments, it is possible not to apply a voltage to the piezoelectric body 5 or 70 when a sensor detects no wafer held on the holding member 41 or 81, and to apply a predetermined voltage to the piezoelectric body 5 or 70 when the sensor detects a wafer W held on the holding member 41 or 81. For example, as shown in FIGS. 24 and 25, a pressure-sensitive sensor 82 may be provided in the receiving surface 46a (45a) of the guide member 46 (45) so that the sensor 82 makes contact with a wafer W when the wafer W is placed on the receiving surface 46a (45a), and the supply of a voltage to the piezoelectric body 5 or 70 may be controlled by means of the pressure-sensitive sensor 82.

More specifically, when a wafer W is held on the holding member 41 or 81 and the pressure-sensitive sensor 82 turns on, the controller 6, for example, outputs to the voltage supply unit 54 or 73 a command to start the application of a voltage to the piezoelectric body 5 or 70. When the wafer W leaves the holding member 41 or 81 and the pressure-sensitive sensor 82 turns off, the controller 6, for example, outputs to the voltage supply unit 54 or 73 a command to stop the application of a voltage to the piezoelectric body 5 or 70. The voltage applied to the piezoelectric body 5 or 70 may be adjusted according to the height position of the holding member 41 or 81 holding the wafer W, or may be kept constant regardless of the height position of the holding member 41 or 81.

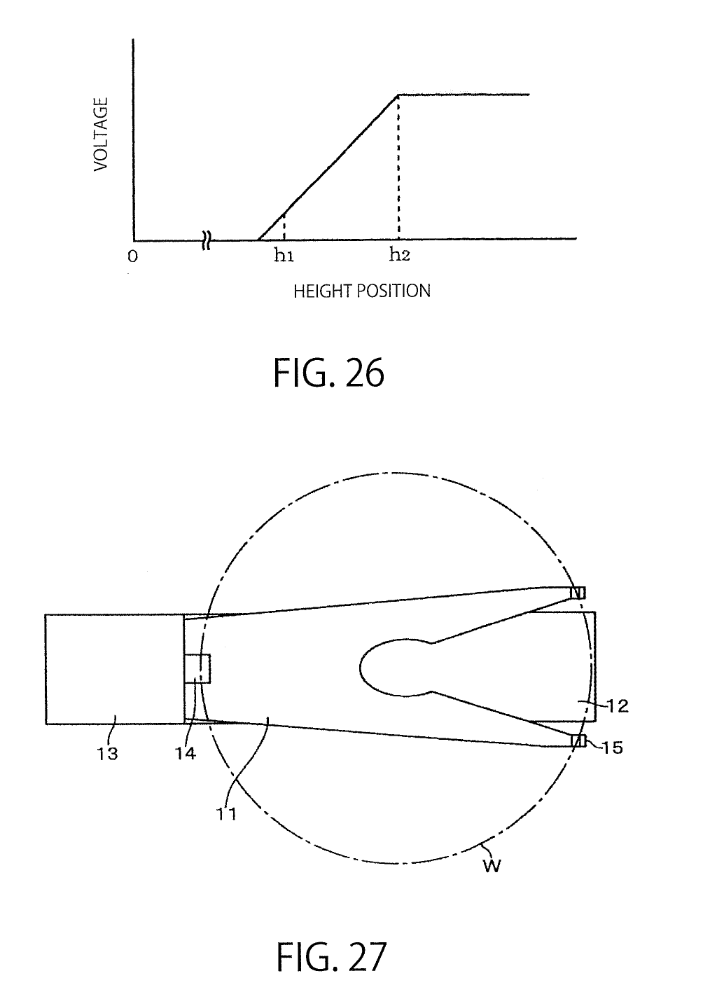

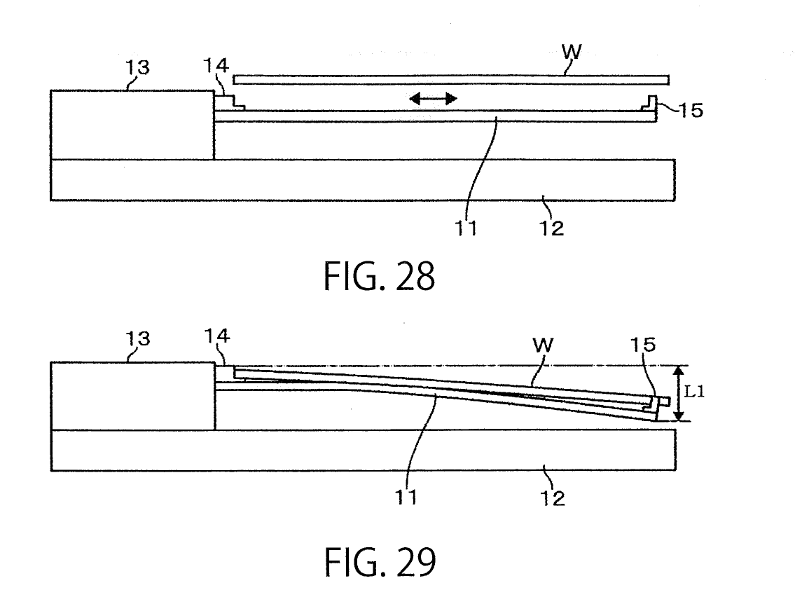

As shown by the voltage pattern in FIG. 26, the application of a voltage to the piezoelectric body 5 or 70 may be started at a time point prior to the time point when the holding member 41 comes into contact with the lower surface of a wafer W at the height position h1 insofar as the voltage is made lower when the wafer W is not held on the holding member 41 than when the wafer W is held on the holding member 41. If the voltage applied to the piezoelectric body 5 or 70 before the holding member 41 makes contact with the lower surface of the wafer W is low as shown in FIG. 26, a large bending stress will not be produced in the holding member 41. Accordingly, the wafer W is unlikely to bounce up when transferring it from a support 22 to the holding member 41 and, when the load of the wafer W comes to be applied to the holding member 41, the holding member 41 becomes a nearly horizontal position.

The piezoelectric body 5 or 70 may be provided either on the upper surface or on the lower surface of the holding member 41 or 81 insofar as the piezoelectric body, when a voltage is applied to it, applies to the holding member 41 or 81 such a bending stress as to warp its distal end upward. It is also possible to provide the piezoelectric body 5 or 70 in the interior of the holding member 41 or 81. Further, the piezoelectric body 5 or 70 may be provided on both the upper and lower surfaces of the holding member 41 or 81, or on the upper surface and/or the lower surface and in the interior of the holding member 41 or 81.

A voltage may be applied to the piezoelectric body 5 or 70 in order to correct or eliminate deflection of the holding member 41 or 81, caused by its own weight when it is secured to the back-and-forth movement member 42. In this case, the degree of deflection of the holding member 41 or 81 becomes larger when a wafer W is held on it. Therefore, a higher voltage is applied to the piezoelectric body 5 or 70 when the wafer W is held on the holding member 41 or 81 than when the wafer W is not held on the holding member 41 or 81. A demand exits to make the holding members 41, 81 thinner in order to reduce the transfer margin. However, a thin holding member 41 or 81, especially for a large-sized wafer, is more likely to bend or reflect by its own weight even when no wafer is held on it. The method of applying a low voltage to the piezoelectric body 5 or 70 to eliminate such an initial deflection is therefore effective especially for such a thin large-sized holding member.

Some piezoelectric bodies, when a voltage of 0 to +E1 is applied thereto, operate to apply to the holding member 41 such a bending stress as to warp it upward, while some piezoelectric bodies operate when a voltage of −E2 to −E3 is applied thereto. A voltage to be applied to a piezoelectric body is selected from an operating voltage range specific for the piezoelectric body. Thus, the expression “voltage is high (low)” herein means that the absolute value of the voltage is high (low).

Though in the above-described embodiments the holding member 41, holding a wafer, is made to take a horizontal position, the holding member 41 may not necessarily take a horizontal position if deflection of the holding member 41 can be reduced.

A transport object is not limited to a semiconductor wafer; other types of substrates, such as a glass substrate, can also be used. The substrate transfer apparatus may transfer a wafer not only to and from a support in a structure in which substrates are held in multiple stages, but also to and from any support (e.g. a support provided in a structure in which a single substrate is placed)

1. A substrate transfer apparatus comprising:
a transfer base;
a plate-like holding member which is configured to hold a substrate and which is horizontally movable back and forth with respect to the transfer base;
a piezoelectric body mounted to the holding member and which, when a voltage is applied thereto, contracts or elongates to apply a bending stress to the holding member; and
a power supply configured to apply a voltage to the piezoelectric body so as to apply a bending stress, which counteracts deflection that has occurred in the holding member, to the holding member.

2. The substrate transfer apparatus according to claim 1, wherein the holding member has a proximal end connected to the transfer base, and a distal end which is a free end, and wherein the power supply is configured to apply a voltage to the piezoelectric body when the holding member holds a substrate, so that the piezoelectric body applies to the holding member such a bending stress as to warp the distal end of the holding member upward.

3. The substrate transfer apparatus according to claim 1, wherein the power supply is configured such that, when the holding member rises from a height position lying below a substrate, held on a support, and receives the substrate from the support, the power supply controls the voltage applied to the piezoelectric body such that an absolute value of the voltage applied to the piezoelectric body after the holding member holds the substrate and the substrate leaves the support is larger than an absolute value of the voltage applied to the piezoelectric body when the holding member lies at a height position at which the holding member begins to make contact with the substrate.

4. The substrate transfer apparatus according to claim 1, wherein the power supply is configured such that, when the holding member rises from a height position lying below a substrate, held on a support, and receives the substrate from the support, the power supply controls the voltage applied to the piezoelectric body according to a predetermined voltage pattern showing a relationship between a relative height position of the holding member with respect to the substrate and the voltage applied to the piezoelectric body.

5. The substrate transfer apparatus according to claim 3, wherein the voltage pattern includes a region in which the voltage increases with rising of the holding member.

6. The substrate transfer apparatus according to claim 3, wherein the voltage pattern includes a region in which the voltage jumps up with rising of the holding member.

7. The substrate transfer apparatus according to claim 1, further comprising a deflection detector provided to detect a degree of deflection of the holding member, wherein the power supply is configured to, based on the degree of deflection detected by the deflection detector, control the voltage applied to the piezoelectric body so that the degree of deflection is reduced to a predetermined level or lower.

8. A substrate transport method comprising:
providing the substrate transfer apparatus according to claim 1;
moving the holding member forward to a position below a substrate held on a support;
raising the holding member relative to the support and allowing the holding member to receive the substrate from the support; and
applying a voltage to the piezoelectric body so that the piezoelectric body applies to the holding member such a bending stress as to counteract deflection of the holding member which would be produced when the holding member holds the wafer.

9. A substrate transport method comprising:
moving a plate-like holding member, mounted to a transfer base, forward to a position below a substrate held on a support;
raising the holding member relative to the support and allowing the holding member to receive the substrate from the support; and
applying a voltage to a piezoelectric body mounted to the holding member, an absolute value of the voltage being larger when the substrate is held on the holding member than when the substrate is not held on the holding member, to contract or elongate the piezoelectric body so that the piezoelectric body applies to the holding member such a bending stress as to warp the distal end of the holding member upward and to thereby counteract deflection of the holding member which would be produced when the holding member holds the wafer.
